(19) United States
(12) Patent Application Publication
(10) Pub. No.: US 2006/0147323 A1
(43) Pub. Date: Jul. 6, 2006

(54) Device for supplying air to fuel cells

(76) Inventors: Manfred Stute, Esslingen (DE); Fritz-Martin Scholz, Hasel (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/538,732

(22) PCT Filed: Dec. 9, 2003
(86) PCT No.: PCT/DE03/04042

§ 371 Date: Jan. 6, 2006

(30) Foreign Application Priority Data
Dec. 12, 2002 (DE) 10258363.3

(51) Int. Cl. F04B 17/00; F04B 35/00; H01M 8/04

(52) U.S. Cl. 417/405; 429/34

(57) ABSTRACT

A device for supplying air to fuel cells includes a compressor connected upstream from the fuel cell, and an expander, which is connected downstream from the fuel cell. The compressor is provided in the form of a claw compressor having at least two intermeshing compressor wheels, and the expander is provided in the form of a claw expander having at least two intermeshing expander wheels.

The present invention relates to a device for supplying air to fuel cells as defined in more detail in the preamble of Claim 1.

A device according to the definition of the species for supplying air to fuel cells is known from DE 197 55 116 C1. Air is supplied to the fuel cell via a compressor and is subsequently expanded in an expander. The expander is operated by the exhaust air of a catalytic burner which is also situated downstream from the fuel cell.

Frequently problematic in these known air supply units is the fact that the fuel cell cannot be supplied with enough air and that, in addition, the compressors and the expanders have low efficiencies.

A pump for generating pressure or partial vacuum is known from WO 00/57062 A1.

The object of the present invention is to provide a device for supplying air to fuel cells which has a simple design and operates effectively.

According to the present invention, this object is achieved by the features recited in Claim 1.

The compressors and expanders of the device according to the present invention for supplying air to fuel cells, which are designed according to the present invention as claw compressors and claw expanders having compressor wheels and expander wheels, enable very high compression ratios and thus a very good fresh air supply to the fuel cell. At the same time, they have a simple design and function reliably.

Advantageous embodiments and refinements of the present invention arise from the subclaims as well as from the exemplary embodiment schematically illustrated in the drawing below.

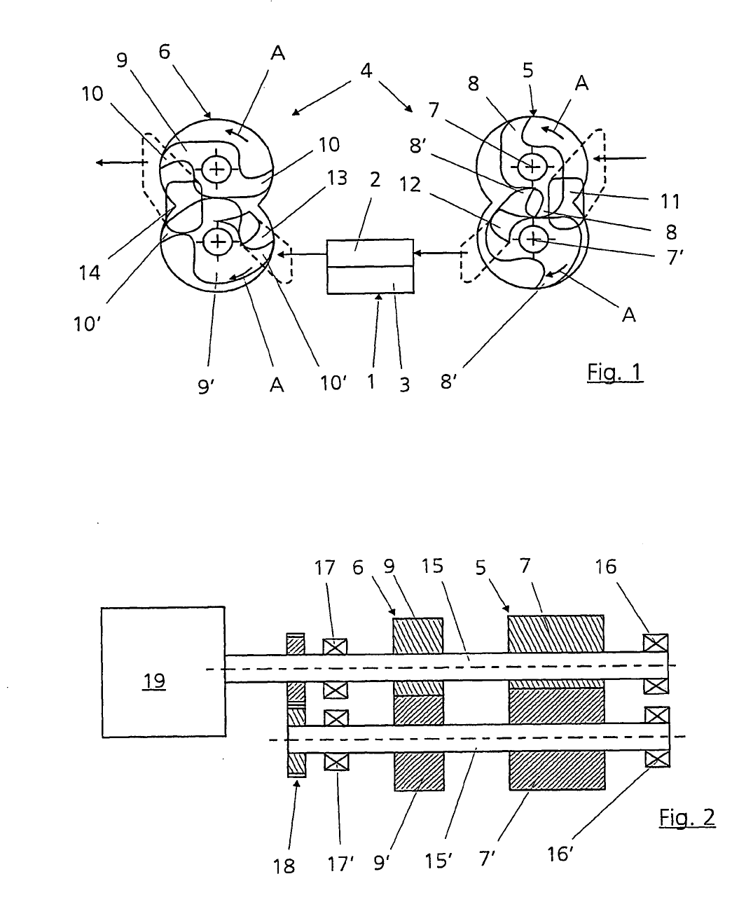

FIG. 1 shows a fuel cell having a device according to the present invention for supplying air;

FIG. 2 shows a section through the device according to the present invention for supplying air;

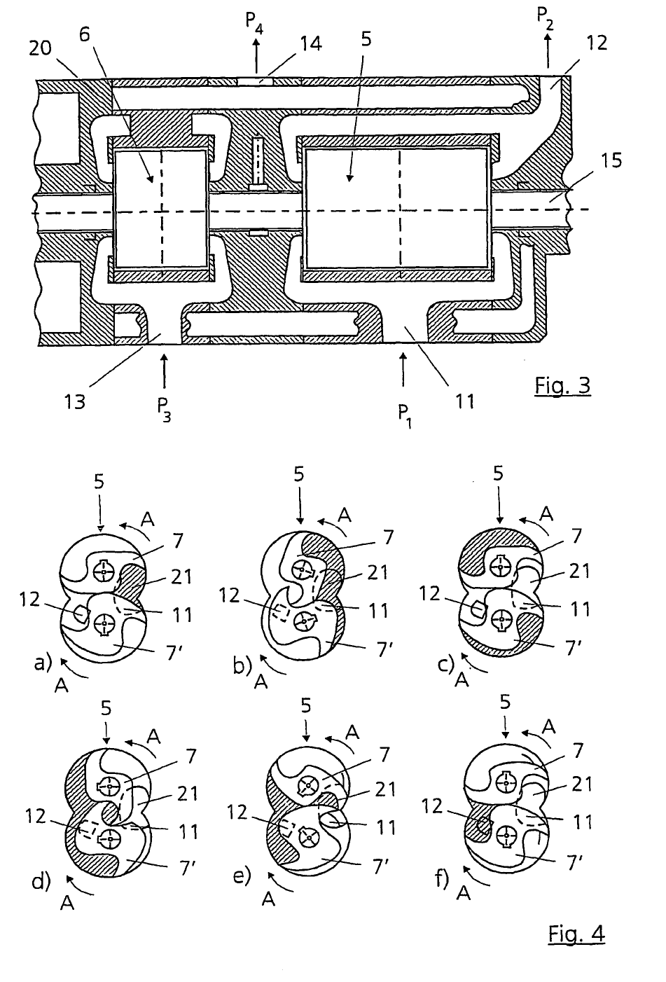

FIG. 3 shows an enlarged representation of a unit including a compressor and an expander, and

FIG. 4 shows the mode of operation of the compressor of the device according to the present invention;

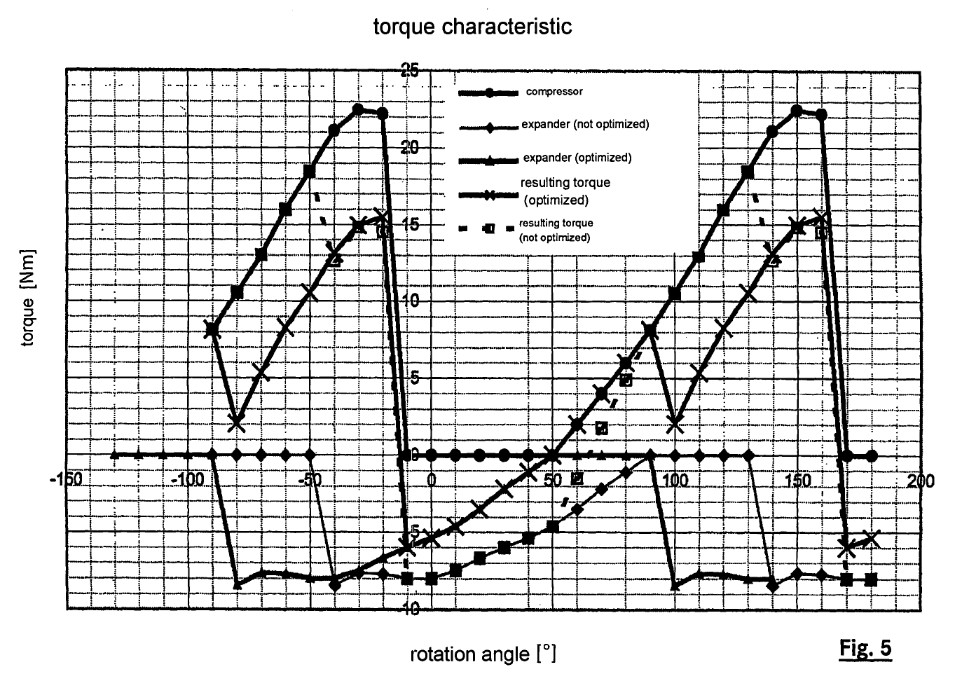

FIG. 5 shows a diagram in which the torque of the compressor and the expander is plotted against the rotation angle.

FIG. 1 shows a highly schematic representation of a fuel cell 1 which, in a manner known per se, has a cathode chamber 2 and an anode chamber 3. A hydrogen-containing gas is supplied to anode chamber 3 in a manner known per se but not illustrated, however. Air or air oxygen is supplied to cathode chamber 2, a device 4 for supplying air to fuel cell 1, described in detail below, being provided for this purpose.

Device 4 has a compressor 5 situated upstream from fuel cell 1 and an expander 6 situated downstream from fuel cell 1. The type of connection of compressor 5 and expander 6 to fuel cell 1 is not explicitly shown; it may, however, be established via standard lines.

As is also apparent in FIG. 1, compressor 5 is designed as a claw compressor and has two compressor wheels 7, 7′ which in turn each have two compressor claws 8, 8′. Expander 6 is in principle identical to compressor 5 and has two expander wheels 9, 9′ which in turn have expander claws 10, 10′. Due to the rotation of compressor wheels 7, 7′, the gas, arriving at compressor 5 at an inlet 11, is taken in at a pressure P₁ and compressed to a pressure P₂ prevailing at an outlet 12, which is later explained in greater detail. The gas is supplied to fuel cell 1 using pressure P₂. A pressure P₃ at which the gas is supplied to expander 6 at an inlet 13 of the expander prevails in the gas downstream from fuel cell 1. Due to the rotation of expander wheels 9, the gas is expanded to a pressure P₄ which prevails at an outlet 14 of expander 6.

The arrows denoted with the letter “A” indicate the respective rotational direction of compressor wheels 7, 7′ and expander wheels 9, 9′. It is thus apparent that compressor 5 and expander 6 have the same rotational direction. However, in order to achieve compression from pressure P₁ to pressure P₂ in compressor 5 and an expansion from pressure P₃ to pressure P₄ in expander 6, compressor 5 and expander 6 have a mirror-inverted configuration.

Pressure ratios P₂/P₁ and P₃/P₄ are predefined in the present case by the geometry of compressor wheels 7, 7′ and expander wheels 9, 9′, i.e., by the design of compressor 5 and expander 6; they may, however, also be adjustable via a mechanism (not shown).

As is apparent in FIG. 2, compressor wheels 7, 7′ and expander wheels 9, 9′ are mounted on common shafts 15, 15′. Shaft 15 as well as shaft 15′ are mounted via two bearing elements 16 and 17 and 16′ and 17′. In addition, common shafts 15 and 15′ are connected by a synchronizing gear unit 18 which ensures a synchronous run of compressor wheel 7 with compressor wheel 7′ and expander wheel 9 with expander wheel 9′. Shaft 15 is connected to a drive motor 19 which drives device 4.

In the described device 4, which represents a combination of compressor 5 and expander 6, the gas compressed in compressor 5 is supplied to expander 6 where residual energy is extracted from the gas via expansion. Due to the common mount, expander 6 supplies the reclaimed power directly to the two shafts 15 and 15′, thereby reducing the power of drive motor 19 required for compressor 5.

As is apparent in FIG. 3, compressor 5 and expander 6 are cooled via expansion cooling. As is apparent in FIG. 2, the cooler expander 6 is situated on the side of synchronizing gear unit 18. Moreover, after exiting expander 6, the gas is used for cooling compressor 5 as well as attached bearing elements 16 and 16′. To achieve this, compressor 5 and expander 6 are situated in a common housing 20 which has a double wall.

FIG. 4 shows the operating principle of compressor 5 in a total of six steps. In step a), due to the rotation of compressor wheels 7, 7′ according to arrow A, the volume of a pumping chamber 21 situated in the area of inlet 11 is increased and the gas is taken in via inlet 11 also referred to as intake channel. Step b) shows a pumping chamber 21 enlarged by the rotation.

The separation of the delivery volumes of the two compressor wheels 7, 7′ results in an isochoric transport of the gas toward the pressure side, i.e., outlet 12. Step d) shows the combination of the two volumes which is associated with compression. However, the gas cannot exit compressor 5 since lower compressor wheel 7′ seals outlet 12. Only when outlet 12 is opened, as is shown in step e), is the pre-compressed gas able to be pushed out, as is shown in step f). In this way, the gas is compressed from pressure P₁ to pressure P₂ and transported toward fuel cell 1.

It is apparent in FIG. 2 that compressor wheels 7, 7′ are substantially wider than expander wheels 9, 9′. Therefore, the pumping chamber of expander 6 (not shown) is smaller than the corresponding pumping chamber 21 of compressor 5. The size of the pumping chamber of expander 6 is generally 0.3 to 0.6 times the size of pumping chamber 21 of compressor 5.

Relatively simple manufacturing methods may be used for manufacturing compressor wheels 7, 7′ and expander wheels 9, 9′, since, in contrast to helical compressors, for example, the geometry of compressor wheels 7, 7′ and expander wheels 9, 9′ is not twisted in the axial direction. Since the compression, as described above, takes place radially rather than in the axial direction, the length or width of compressor wheels 7, 7′ and expander wheels 9, 9′ is smaller than their diameter so that a compact design may be implemented, in particular when compressors and expanders have a multi-stage design. Such a multi-stage design may be utilized to implement greater pressure differences or to achieve independent volume flows under different individual pressures.

FIG. 5 shows a torque characteristic of compressor 5 and expander 6 plotted against the rotation angle of compressor wheels 7, 7′ and expander wheels 9, 9′. Since compressor 5 compresses in the rotational direction while expander 6 expands in the rotational direction and since, as described above, the lengths of compressor wheels 7, 7′ and expander wheels 9, 9′ are different, the illustrated torque characteristics result. Expander 6 is initially in-phase with compressor 5, which makes it possible, via a suitable angular shift, to reduce the difference between the maximum torque and the minimum torque by approximately 20%.

1-14. (canceled)

15. A device for supplying a gas to a fuel cell comprising:
a claw compressor disposed upstream from the fuel cell and having first and second engaging compressor wheels; and
a claw expander disposed downstream from the fuel cell and having first and second engaging expander wheels.

16. The device as recited in claim 15, wherein each of the first and second compressor wheels have at least two compressor claws and each of the first and second expander wheels have at least two expander claws.

17. The device as recited in claim 15, further comprising first and second shafts, and wherein the first compressor wheel and the first expander wheel are mounted on the first shaft and the second compressor wheel and the second expander wheel are mounted on the second shaft.

18. The device as recited in claim 17, further comprising a synchronizing gear unit connecting the first and second shafts.

19. The device as recited in claim 15, wherein the claw compressor and the claw expander have a same rotational direction and a mirror-inverted configurations.

20. The device as recited in claim 15, wherein a configuration of the claw compression defines a compressor ratio of the gas produced by the claw compressor and a configuration of the claw expander defines an expansion ratio of the gas produced by the claw expander.

21. The device as recited in claim 15, wherein a compression ratio of the gas produced by the claw compressor and an expansion ratio of the gas produced by the expander are adjustable.

22. The device as recited in claim 15, wherein the claw compressor includes a compressor pumping chamber and the claw expander includes and expander pumping chamber, the expander pumping chamber being smaller than the compressor pumping chamber.

23. The device as recited in claim 22, wherein a size of the expander pumping chamber is 0.3 to 0.6 times the size of the compressor pumping chamber.

24. The device as recited in claim 18, wherein the compressor and the expander are configured to be cooled by expansion cooling.

25. The device as recited in claim 24, wherein the expander disposed on a side of the synchronizing gear unit so as to provide expansion cooling of the compressor and the expander.

26. The device as recited in claim 24, wherein a gas exiting the expander is provided to the compressor.

27. The device as recited in claim 24, wherein the compressor and the expander are disposed in a common housing.

28. The device as recited in claim 27, wherein the housing has a double wall.
